(19) United States
(12) Patent Application Publication
(10) Pub. No.: US 2008/0172699 A1
(43) Pub. Date: Jul. 17, 2008

(54) Channel Navigation on Integrated Atsc Tuner Tv Set

(76) Inventor: Rajeev Madhukar Sahasrabudhe, Fishers, IN (US)

Correspondence Address: Joseph J. Laks;Thomson Licensing LLC, 2 Independence Way, Patent Operations, PO Box 5312, PRINCETON, NJ, 08543, US

(21) Appl. No.: 11/884,494

(22) PCT Filed: Feb. 16, 2006
(86) PCT No.: PCT/US2006/005470

§ 371 Date: Aug. 16, 2007

(30) Foreign Application Priority Data
Feb. 16, 2005 (US) PCT/US2005/004813
Feb. 17, 2005 (US) PCT/US2005/005106

(51) Int. Cl. G06F 3/00

(52) U.S. Cl. 725/56

(57) ABSTRACT

A method and apparatus are described for allowing a user to select one of an analog signal source and a digital signal source in a signal processing device, wherein the signal processing device compares an analog channel number with a digital channel list, determines based on results of the comparison if a corresponding digital channel is available, and, if available, stores a corresponding digital channel number and selects the corresponding digital channel determined from the digital channel list in response to a command from a user. A method and apparatus are also described as above but further determining based on the comparison if a corresponding digital channel is available, and, if available, prompting the user via an onscreen display (OSD) to select the digital signal.

### FIELD OF THE INVENTION

The present invention relates to the area of channel navigation on signal processing devices, including an automatic prompt via an onscreen display (OSD) pop-up.

### BACKGROUND OF THE INVENTION

During the transition period as broadcasters change to digital HDTV broadcasting from NTSC analog broadcasting, television stations may simulcast. That is, stations may simultaneously broadcast their programs on two channels/signal sources allotted for their use by the Federal Communications Commission (FCC). Each of the two channels will encompass 6 MHz of bandwidth and need not be contiguous. One of the two sources will be the channel currently assigned to the station for NTSC analog broadcasts and the other will be for station use for HDTV digital broadcasts. It is, however, likely that viewers will regard the transmissions as one source/channel because the same program is carried simultaneously on both channels. Analog broadcasting may be off-air or cable.

Signal processing devices produced during this transition period usually have two tuners. Signal processing devices may include, but are not limited to, set top boxes (STBs), video cassette players and recorders (VCPs and VCRs), digital video disc players (DVDs) as well as televisions (TVs). One of the tuners and corresponding signal processing circuitry/module(s) is for receiving and processing HDTV signals and the other tuner and corresponding signal processing circuitry/module(s) is for receiving and processing NTSC analog signals.

In signal processing devices that have separate inputs and tuners to tune to the available off-air analog (NTSC) channels and digital high definition (ATSC) channels and where it is not possible to have all the channels found by the tuners to be populated in a single channel list the user has to toggle between the digital and analog tuners/inputs to be able to view the respective channels in the channel lineup. Many times in such a situation when the user is watching an analog (NTSC) channel say CH 13 there is a digital (ATSC) channel from the same broadcaster having the same broadcast in high definition (HD). If the user wishes to select/switch to the digital broadcast instead of the analog broadcast there is no easy way for him/her to go to the digital channel from the same broadcaster. Typically the user has to first select inputs/tuners to view the digital channel lineup and then manually tune to the channel he/she is looking for.

Some manufacturers of digital (ATSC) receivers have tuners that have the capability to tune to both analog as well as digital channels using the same tuner or at least to populate the channels found in case there are two tuners into one comprehensive channel list. In this case the digital channels will be in the channel lineup with the analog channels. The digital channels, however, are listed in the channel line-up according to their pseudo channel number. The pseudo channel numbers were created by the NAB (National Association of Broadcasters) primarily to make channel number entry easy for digital channels, but that cannot be achieved until all of the broadcasts become digital. Also the digital channels have pseudo channel numbers that are only two digits e.g. digital channel 13-1 could have a pseudo channel number 46, and in the absence of the above invention, after having tuned to the digital tuner/input the user could enter the pseudo channel number instead of the actual main and sub-channel numbers for a channel. It is obvious that since the pseudo channel numbers do not relate in any way to the digital channel number and/or the analog channel number for a particular broadcaster, the user would have to remember the pseudo channel numbers for all the digital channels available to him/her.

In a scenario where the user is viewing an off-air analog (NTSC) channel number 13, the user might remember that the same broadcast is available in high definition. Since he/she does have a high definition signal processing devices he/she might as well view the broadcast in HD quality rather than standard definition (SD) quality, so the user/viewer may wish to select the ATSC signal source/channel. When the user switches the signal processing device's tuners/inputs from the analog tuner (NTSC) to the digital tuner (ATSC) the channel the signal processing device tunes to is either the first channel/signal source in the list of digital channels or the last signal source/channel that was tuned to when the user was watching a digital broadcast. Now the user has to navigate to locate the correct/equivalent digital broadcast by changing channels to tune to the correct digital channel.

Yet another prior art method of changing a channel/selecting a signal source is to directly tune to the desired channel number by, for example, using a remote control device. There are numerous problems, however, with this approach. The first problem being the digital channel numbers have two parts namely—a main channel number and a sub-channel number. If the tuner does not support data broadcasts then the sub-channel number can be a two digit number such as 13-02, where 13 is the main channel number and 02 being the sub-channel number. Currently, as the broadcasts are both analog as well as digital this represents an inherent difference in the channel entry method for the two sources with the digital channel number entry requiring entries for both the main as well as the sub-channel numbers.

The status displays in the HDTV's indicate the incoming signal resolution to the user. With the current channel lineup in most areas where the analog broadcast is still available with the high definition (HD) broadcast the user ends up watching an analog off-air or analog cable broadcast channel simply because the user does not know that the same broadcast channel is available as a digital High Definition off-air broadcast or that he/she has to search for the corresponding digital channel or has to change channels to the corresponding digital channel.

### SUMMARY OF THE INVENTION

The present invention solves the problems discussed above by taking the user directly to the digital channel from the same broadcaster when the user selects tuners/inputs from analog to digital. This invention offers an easy and intuitive way for the user to navigate through the available analog channels as well as digital channels when it is not possible to have both analog and digital channels in one channel list. The user is not required to remember the pseudo channel number or the main and sub-channel number for a digital channel. To tune to a particular signal source/digital channel the user simply needs to select an analog channel and switch inputs/tuners to select the corresponding digital channel.

Using the present invention, once the user changes the tuners/inputs from analog to digital the signal processing device would automatically identify the digital channel from the same broadcaster as the analog channel the signal processing device was tuned to prior to the user changing the tuner/input and directly tune to that channel. The signal processing device is able to automatically determine if the associated digital channel/signal source is available or not because all the channels found for both the analog and digital spectrum will be stored in non-volatile memory (NVM). In one embodiment, the signal processing device menu system has an option where the user sets his/her preference for the channel tuned to after the analog-to-digital or digital-to-analog tuner/input switch so as to tune to the channel from the same broadcaster or to the last tuned channel.

The method and apparatus of the present invention allow a user to select one of an analog signal source and a digital signal source in a signal processing device, wherein the signal processing device compares an analog channel number with a digital channel list, determines based on results of the comparison if a corresponding digital broadcast is available, and, if available, stores a corresponding digital channel number and selects the corresponding digital channel determined from the digital channel list in response to a command from a user.

The present invention also describes an automatic prompt via an OSD pop-up that informs the user if the broadcast channel he/she is viewing (if analog off-air) is also available in HD allowing the user to use his/her HDTV to its fullest potential. The invention allows the signal processing device software to prompt the user if he/she is currently viewing an analog off-air or cable broadcast channel when the same broadcast is available as a digital HD off-air channel. This enables the user to view the channel at the maximum broadcast resolution and quality thereby enhancing the viewing experience and helping utilize the potential of the HDTV to the fullest possible. This is accomplished by user selection of an ATSC signal source/channel or a NTSC signal source/channel.

In this invention the signal processing device software has the ability to store the found ATSC digital and NTSC analog channels in the same manner as is in HDTVs today. In addition to this storing ability the signal processing device software also has a hard-coded matrix that contains the correspondence between a particular analog off-air channel and its ATSC digital HDTV channel for different viewing areas. Thus, when the user performs a channel search for both analog off-air and NTSC digital HDTV channels, in one embodiment both lists are stored in non-volatile memory (NVM). If the user now tunes the signal processing device to an analog signal source/channel, the signal processing device will check the matrix to determine if a corresponding ATSC digital HDTV channel is available and was located and stored in NVM during the channel search. If the software determines that an ATSC digital HDTV channel is available with the same broadcast and that the ATSC digital HDTV channel was found and stored in the digital channel list in NVM, an OSD will pop-up so informing the user/viewer and also providing the user with an option for the user to depress a particular remote control key to make the signal processing device directly tune to that ATSC digital HDTV channel.

A method and apparatus are also described for allowing a user to select an analog signal source or a digital signal source in a signal processing device by comparing by the signal processing device an analog channel number with a digital channel list, determining based on the comparison if a corresponding digital broadcast is available, and, if available, prompting the user via an onscreen display (OSD) to select the digital signal and selecting said corresponding digital channel determined from the digital channel list in response to a command from the user.

Clearly for analog off-air broadcast to cease totally is going to take a long time and users will have to unnecessarily live with the difficulty in use of their signal processing devices and other consumer electronics (CE) devices that can tune to both analog and digital off-air broadcasts today. This invention not only provides an immediate solution to this problem but also provides for an easy and seamless transition for the user when all the off-air broadcast becomes digital.

### BRIEF DESCRIPTION OF THE DRAWINGS

These and other aspects, features and advantages of the present invention will become apparent from the following detailed description of preferred embodiments, which is to be read in connection with the accompanying drawings.

FIG. 1 is a block diagram of an exemplary implementation of the present invention.

FIG. 2A is a flowchart illustrating an exemplary method of implementing the present invention.

FIG. 2B is a flowchart illustrating an exemplary method of implementing the present invention.

FIG. 3 is a screen shot of an exemplary OSD pop-up display of the present invention.

### DETAILED DESCRIPTION OF THE PREFERRED EMBODIMENTS

The present invention is directed to an interface by which the user/viewer can institute a change from an analog broadcast to a corresponding digital (HDTV) broadcast if such a broadcast is available. NTSC analog channel numbers include a major channel number followed by the minor channel number 0. Users/viewers are, however, not aware of this and only use the major channel number for a NTSC analog channel. All ATSC digital HDTV channel numbers corresponding to NTSC analog channels have minor channel numbers of 1 or greater. For example, for NTSC analog channel 13, which is technically 13-0, has corresponding ATSC digital HDTV channels (if available and being broadcast) of 13-1, 13-2 etc.

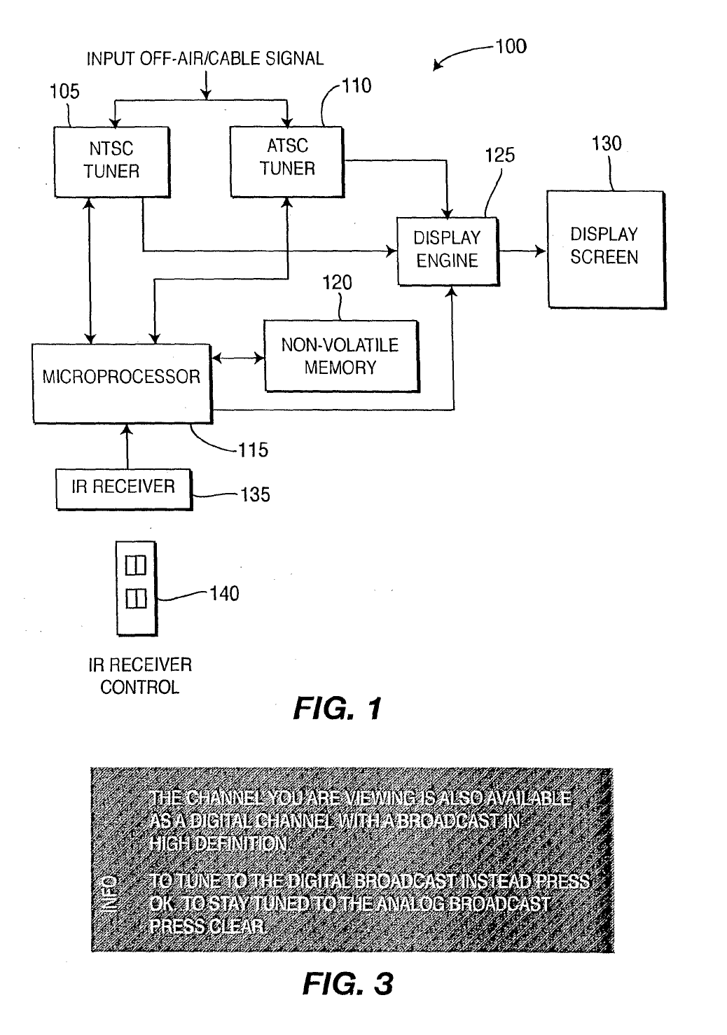

FIG. 1 is a block diagram of an exemplary implementation of the present invention. A signal processing device 100 manufactured/produced during the transition period has two tuners and two corresponding sets of signal processing circuitry. One tuner and corresponding set of signal processing circuitry 105 is for receiving and processing NTSC analog signals. The other tuner and corresponding set of signal processing circuitry 110 is for receiving and processing ATSC digital HDTV signals. Each tuner and corresponding set of signal processing circuitry receives off-air/cable signals as input. Each tuner and corresponding set of signal processing circuitry 105,110 is also in communication with the signal processing device's microprocessor 115. The signal processing device's microprocessor is further in communication with the signal processing device's non-volatile memory 120. Non-volatile memory is used to store the channels list(s) as well as the software to implement the present invention. Each tuner and corresponding set of signal processing circuitry 105,110 may also be in communication with the signal processing device's display engine 125, which may also drive display screen 130 of the signal processing device. The signal processing device's microprocessor 115 also receives information/commands from an infrared (IR) receiver 135, which is controlled by an IR remote control device 140. The user/viewer controls the switching between analog and digital channels via the IR remote control device 140. The user also controls the switching between analog and digital channels by using the buttons on the front panel of the receiver but most users/viewers today rely on the IR remote control device. Usually, the remote control devices and the corresponding receivers use IR technology but they need not.

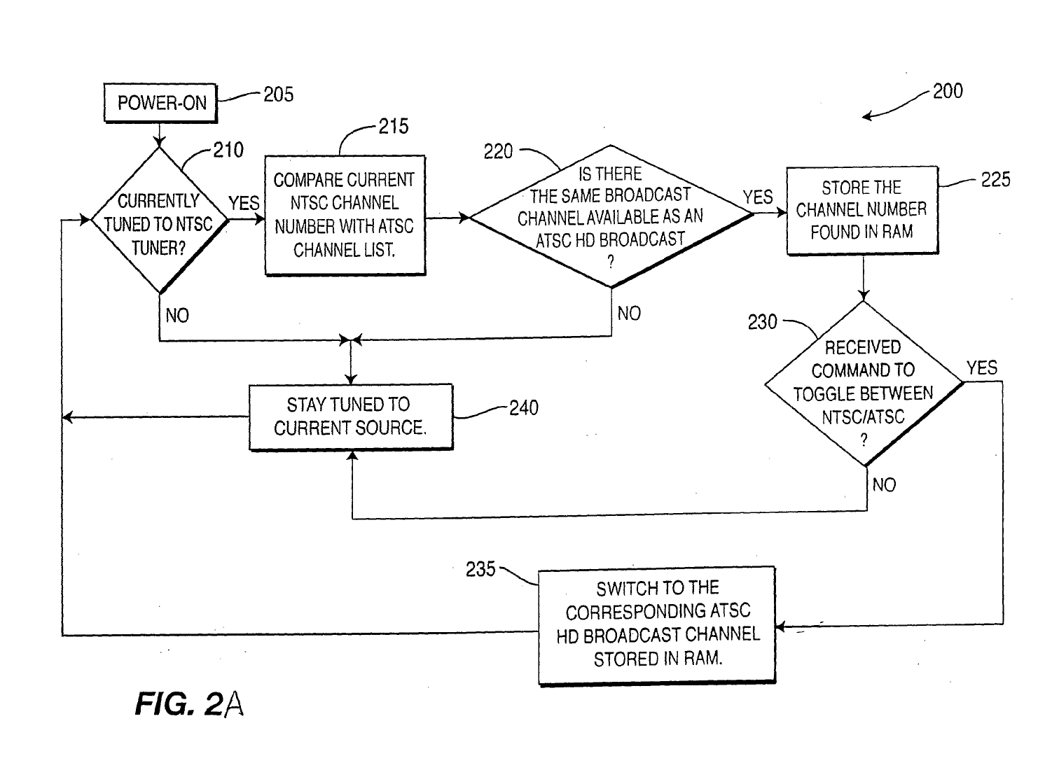

FIG. 2A is a flowchart illustrating an exemplary method 200 of implementing the present invention. Upon powering on the signal processing device at 205, the signal processing device determines if it is currently tuned to an NTSC analog channel at 210. If the signal processing device is currently tuned to an NTSC signal source/channel then the signal processing device compares the currently tuned NTSC channel number with the ATSC digital HDTV channel list, which maybe in non-volatile memory at 215. The comparison is made, for example, by comparing the closed captioning information the receiver receives for a NTSC analog channel and an ATSC digital HDTV channel. In the alternative, the signal processing device could use any of the data that is carried in the vertical blanking interval (VBI) to perform the comparison in order to identify the corresponding ATSC digital channel for an NTSC analog channel. The VBI carries information such as V-chip ratings, time and day, program information, electronic program guide (EPG) information, and second audio program (SAP) if available.

At 220 a determination is made by the signal processing device based on the results of the comparison at 215 if there is an ATSC digital HDTV broadcast channel available corresponding to the currently tuned NTSC analog channel. If an ATSC digital HDTV broadcast is available then the corresponding ATSC channel is stored in non-volatile memory associated with the receiver's microprocessor at 225. The receiver could anytime thereafter receive a command from a user/viewer to switch/toggle between the currently tuned NTSC analog channel and the corresponding ATSC digital HDTV channel at 230. This command is received via the IR receiver module of the signal processing device when the user/viewer presses an appropriate button on a remote control device, for example . Upon receipt of such a command, the signal processing device to select the corresponding ATSC digital HDTV channel using the information, which may be in the non-volatile memory at 235. If no command to select the corresponding ATSC digital HDTV channel is received then the signal processing device remains tuned to the NTSC analog channel as indicated at 240. The signal processing device then returns to 210 when the user/viewer changes to another NTSC analog channel.

FIG. 2B is a flowchart illustrating a exemplary method of implementing the present invention. Steps 205-220 are the same as in FIG. 2A so the description will not be repeated. At 220 a determination is made by the signal processing device's microprocessor based on the results of the comparison at 215 if there is an ATSC digital HDTV broadcast channel available corresponding to the currently tuned NTSC analog channel. If an ATSC digital HDTV broadcast is available then the user/viewer will be prompted with an OSD to press “OK” in order to tune to the ATSC digital HDTV broadcast at 225B, the channel number for which was stored in the non-volatile memory associate with the signal processing device's microprocessor. At 230B, determine if the user has pressed “OK” in order to switch the ATSC digital HDTV channel (using the HDTV tuner). This command may be received via the IR receiver module of the signal processing device when the user/viewer presses an appropriate button on a remote control device. If the user has pressed “OK” then select the corresponding ATSC digital HDTV broadcast at 235B. If the user has not pressed “OK” but has instead pressed “CLEAR” then clear the OSD pop-up from the screen/display at 233. Upon receipt of such a command, the microprocessor selects the corresponding ATSC digital HDTV channel using the information in the non-volatile memory at 235B. If neither an “OK” nor a “CLEAR” command are received then the signal processing device stays tuned to the NTSC analog channel as indicated at 240B. The signal processing device then goes back to 210 when the user/viewer changes to another NTSC analog channel.

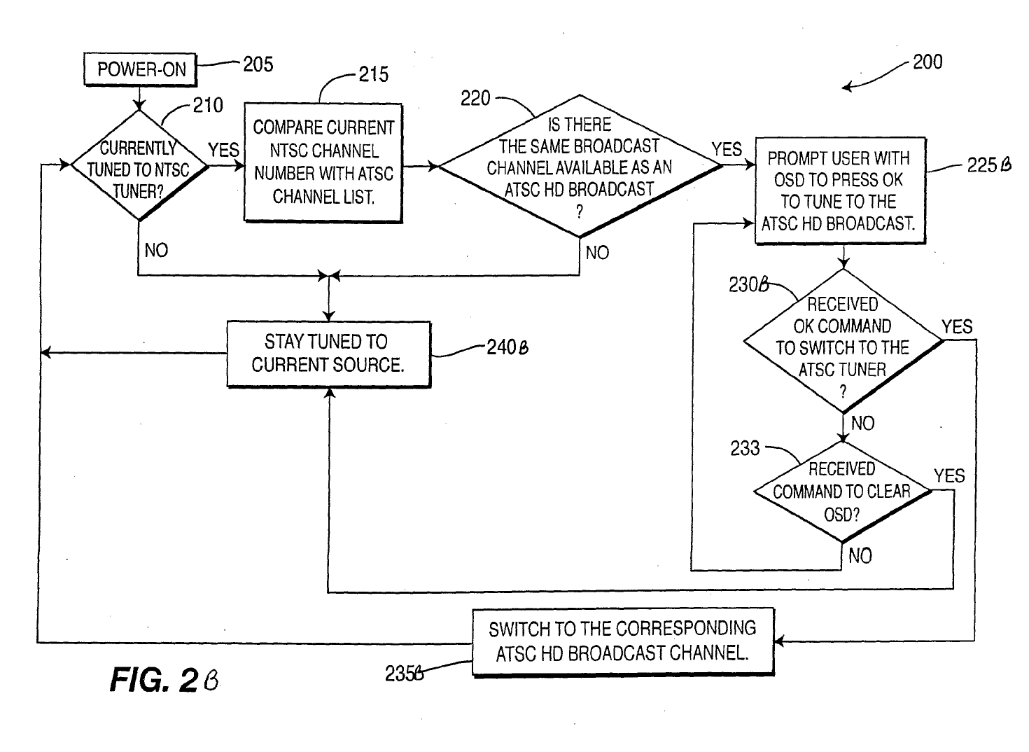

FIG. 3 is an exemplary OSD pop-up of the present invention. In the example OSD shown in FIG. 3 the user can simply press “OK” to directly tune to the corresponding digital channel with the HD broadcast without having to enter any channel numbers. Any button/key could be used and the invention is not limited to using the “OK” and the “CLEAR” buttons.

In another embodiment the signal processing device also prompts/queries the user, whether, in the future, the signal processing device should always tune to the ATSC digital HDTV broadcast instead of the analog broadcast, thereby preventing unnecessary pop-ups of the above OSD. When the user selects to always tune to the ATCS digital HDTV channel/signal source instead of the analog channel the respective analog channel is simply removed from the CH−/+button loop, but the analog channel number is not discarded so the user could still tune to that analog signal source/channel using direct digit input in the future if he/she so desires.

In yet another embodiment, the signal processing device software catalogs the cable channels, in case the user also has cable, using the vertical blanking interval (VBI) information of the channel currently tuned to and then attempt to locate the associated high definition off-air channel, if available, and prompt the user of its availability. The VBI carries information such as V-chip ratings, time and day, program information, electronic program guide (EPG) information, and second audio program (SAP), if available. This solves the problem of the channel numbers for both the analog cable and digital high definition off-air broadcast being the same but the broadcasters and the broadcast programs actually being totally different.

Another way to accomplish an accurate prompt would be to compare the closed captioning data that is received in the VBI. This embodiment provides for more accuracy than the prompt provided to the user as the closed captioning data for an analog broadcast channel for a particular broadcast would be the same for the broadcast digital channel as well. Any of the VBI data could be used to perform the comparison or any combination of the VBI data could be used to perform the comparison.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. A method for allowing a user to select one of an analog signal source and a digital signal source in a signal processing device, the method comprising:
comparing by said signal processing device an analog channel number with a digital channel list; and
determining, by said signal processing device, based on results of said comparison if a corresponding digital channel is available, wherein said determining act comprises comparing one of closed captioning information and audio program information that said signal processing device receives for said analog channel and closed captioning information and audio program information that said signal processing device receives for said digital channel.

2. The method according to claim 1, wherein if said digital channel is available, storing a corresponding digital channel number; and
selecting said corresponding digital channel determined from said digital channel list in response to a command from a user.

3. The method according to claim 1, wherein if said digital channel is available, prompting said user via an onscreen display (OSD) to select said digital signal; and
selecting said corresponding digital channel determined from said digital channel list in response to a command from a user.

4. The method according to claim 1, wherein said digital channel list is stored in non-volatile memory associated with a microprocessor of said signal processing device.

5. The method according to claim 4, wherein said corresponding digital channel number is stored in said non-volatile memory.

6-10. (canceled)

11. The method according to claim 3, further comprising receiving a command from said user to clear said OSD, wherein clearing said OSD also results in said receiver remaining tuned to said analog signal.

12. An apparatus for allowing a user to select one of an analog signal source and a digital signal source in a signal processing device, comprising:
means for comparing by said signal processing device an analog channel number with a digital channel list; and
means for determining, by said signal processing device, based on results of said comparison if a corresponding digital channel is available, wherein said means for determining comprises means for comparing one of closed captioning information and audio program information that said signal processing device receives for said analog channel and closed captioning information and audio program information that said signal processing device receives for said digital channel.

13. The apparatus according to claim 12, wherein if said digital channel is available, storing a corresponding digital channel number; and
means for selecting said corresponding digital channel determined from said digital channel list in response to a command from a user.

14. The apparatus according to claim 12, wherein if said digital channel is available, prompting said user via an onscreen display (OSD) to select said digital signal;
means for selecting said corresponding digital channel determined from said digital channel list in response to a command from a user.

15. The apparatus according to claim 12, wherein said digital channel list is stored in non-volatile memory associated with a microprocessor of said signal processing device.

16. The method according to claim 13, wherein said corresponding digital channel number is stored in said non-volatile memory.

17-21. (canceled)

22. The apparatus according to claim 14, further comprising means for receiving a command from said user to clear said OSD, wherein clearing said OSD also results in said receiver remaining tuned to said analog signal.
